(19) United States
(12) Patent Application Publication
(10) Pub. No.: US 2025/0243095 A1
(43) Pub. Date: Jul. 31, 2025

(54) UV RADIATION APPARATUS FOR TREATING FLUIDS

(71) Applicant: TROJAN TECHNOLOGIES GROUP ULC, London (CA)

(72) Inventors: David OLSON, London (CA); Michael Sasges, Victoria (CA)

(73) Assignee: TROJAN TECHNOLOGIES GROUP ULC, London (CA)

(21) Appl. No.: 18/422,226

(22) Filed: Jan. 25, 2024

(51) Int. Cl. C02F 9/00; C02F 1/32

(52) U.S. Cl. CPC C02F 9/00; C02F 1/325; C02F 2201/3222; C02F 2201/3225; C02F 2201/3228; C02F 2201/326; C02F 2307/14

(57) ABSTRACT

An apparatus for treating fluid with ultraviolet radiation includes a head portion with an inlet conduit that is configured to convey the fluid away from an inlet along a length direction of the inlet conduit and an outlet conduit that is configured to convey the fluid along a length direction of the outlet conduit. The length direction of the inlet conduit and the length direction of the outlet conduit are collinear. A reactor vessel is coupled to the head portion. An LED light source is configured to emit ultraviolet radiation into the inner vessel, and at least a portion of the LED light source is immersed in fluid flowing toward the outlet conduit so that the fluid cools the LED light source. An adapter unit removably attaches reactor vessel and the head portion.

### BACKGROUND

Disinfection of water is critical to ensure water quality. Water sources can be contaminated with pathogens, such as bacteria, viruses, fungi, algae, molds, and yeasts, making the water unsafe for consumption by humans and animals. One way of disinfecting water is by ultraviolet (UV) radiation treatment, in which water is irradiated with UV light. UV radiation damages the DNA, RNA, and protein in pathogens, and inactivates them, making the water safe for use and consumption. UV radiation treatment can be used in residential, municipal, commercial, and industrial water systems.

Installation of a conventional UV radiation treatment apparatus, for example, onto an existing water supply, may require expensive, bulky modifications to couple the UV radiation treatment apparatus onto the existing piping. This is especially true for a residential system which may have limited space around the existing household piping. In addition, maintenance of a conventional UV radiation treatment apparatus can be difficult, and may require the owner to disassemble the entire apparatus and uncouple it from the plumbing, e.g., to perform maintenance on the UV light source, to clean the apparatus, or to perform other routine maintenance. Facilitating maintenance may require the time-consuming and expensive installation of a bypass line and associated valves to permit continued water flow to the residence while the system is removed for maintenance.

### SUMMARY

Aspects of the present disclosure provide an apparatus that can effectively treat fluid with UV radiation while overcoming one or more of the above challenges.

According to one aspect, the disclosure provides an apparatus for treating fluid with ultraviolet (UV) radiation, the apparatus comprising a head portion including an inlet conduit that is configured to receive fluid entering the apparatus at an inlet and convey the fluid away from the inlet along an inlet direction of the inlet conduit, and an outlet conduit that is configured to convey the fluid along an outlet direction of the outlet conduit toward an outlet, wherein the inlet direction and the outlet direction are co-linear, a reactor vessel coupled to the head portion, the reactor vessel including, an outer vessel, an inner vessel housed within the outer vessel, and an outer volume formed between the inner vessel and the outer vessel and defining a flow path which receives the fluid at a position downstream of the inlet conduit and upstream of the outlet conduit, and is configured to convey the fluid along a first direction toward an inlet of the inner vessel, wherein the fluid then flows within the inner vessel along a second direction that is transverse to the inlet direction and the outlet direction, an LED light source unit configured to emit UV radiation into the inner vessel, wherein the LED light source unit is arranged so at least a portion of the LED light source unit is immersed in fluid flowing in the apparatus so that the fluid cools the LED light source unit, and an adapter unit that (i) is positioned between the reactor vessel and the head portion, (ii) is configured to removably attach to the head portion, and (iii) is configured to removably attach to the reactor vessel.

According to another aspect, the disclosure provides a retrofit fluid treatment apparatus for treating a fluid with ultraviolet (UV) radiation, the apparatus comprising, (i) a reactor vessel through which the fluid flows and is treated with the UV radiation, (ii) an LED light source unit configured to emit the UV radiation into the reactor vessel, and (iii) an adapter unit having (i) a first connection portion by which the adapter unit can be removably attached to a head portion that has an inlet conduit and an outlet conduit that extend in the same lengthwise direction, the inlet conduit and outlet conduit being attachable to piping that conveys the fluid, and (ii) a second connection portion by which the adapter unit can be removably attached to the reactor vessel, wherein the adapter unit is configured to form a continuous fluid conduit with the head portion and reactor vessel when attached thereto so that a flow path of the fluid enters the head portion at the inlet conduit of the head portion, is then directed to flow into the adapter unit, is then directed to flow through the reactor vessel in a direction that is transverse to the lengthwise direction of the inlet conduit and the outlet conduit of the head portion, and is then directed to flow through the outlet conduit of the head portion.

### BRIEF DESCRIPTION OF THE DRAWINGS

FIG. 1 is a perspective cross-sectional view of a fluid treatment apparatus with an adapter unit;

FIG. 2 is a perspective view of a light source unit of the fluid treatment apparatus;

FIG. 3 is a perspective cross-sectional view of a fluid treatment apparatus with an adapter unit and a supplemental filter;

FIG. 4 is a perspective cross-sectional view of a fluid treatment apparatus without an adapter unit, including a reactor vessel that comprises a light source, and a head portion is joined directly to the reactor vessel;

FIG. 5 is a perspective cross-sectional view of a fluid treatment apparatus without an adapter unit, including a head portion that comprises a light source, and the head portion is joined directly to a reactor vessel;

FIG. 6 is a perspective cross-sectional view of a fluid treatment apparatus with an adapter unit and with a light source unit mounted in a reactor vessel;

FIG. 7 is a front view of a fluid treatment apparatus with an retaining ring;

FIG. 8 is an exploded view of the fluid treatment apparatus with the retaining ring;

FIG. 9 is a cross-sectional view of the fluid treatment apparatus with the retaining ring; and

FIG. 10 is a cross-sectional view of a fluid treatment apparatus with a retaining ring.

### DETAILED DESCRIPTION OF EMBODIMENTS

In the following description, numerous details are set forth to provide an understanding of the present disclosure. However, it may be understood by those skilled in the art that the systems and methods of the present disclosure may be practiced without these details and that numerous variations or modifications from the described embodiments may be possible.

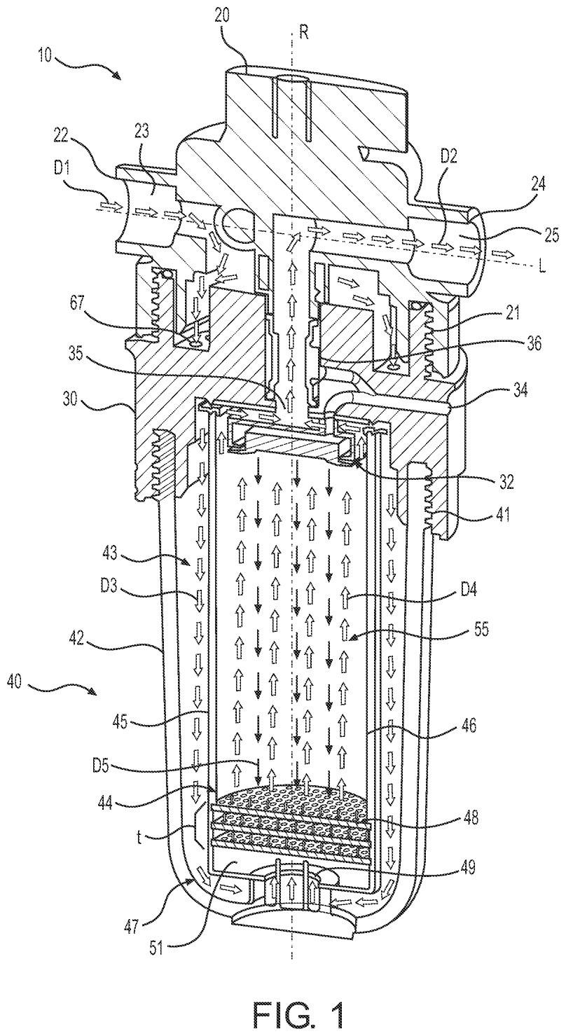

FIG. 1 shows a perspective view of a fluid treatment apparatus 10. The fluid treatment apparatus 10 includes a head portion 20 and a reactor vessel 40. The head portion 20 has an inlet 22 and an outlet 24. The inlet 22 receives fluid entering the apparatus, e.g., from other piping or plumbing (not shown). The inlet 22 can be an aperture that is part of an inlet conduit 23 that conveys fluid in a direction D1 that is along a lengthwise direction of the inlet conduit 23 away from the inlet 22. In FIG. 1, directions D1 and D2 extend substantially along a longitudinal axis L of the head portion 20. The outlet 24 can be an aperture that is part of an outlet conduit 25. The outlet conduit 25 conveys the fluid in a direction D2 that is along a lengthwise direction of the outlet conduit 25 toward the outlet 24 where the fluid is discharged from the apparatus 10. D1 and D2 can be co-linear, i.e., extending in the same direction as shown in FIG. 1 or a parallel direction. The lengthwise directions of the inlet conduit 23 and outlet conduit 25 can similarly be arranged co-linearly, including coaxially or parallel to each other. The inlet conduit 23 and the outlet conduit 25 are not particularly limited to any length or configuration. For example, the inlet conduit 23 and the outlet conduit 25 may have lengthwise dimensions extending along axis L that are shorter than appear in FIG. 1, and in some cases may be substantially smaller compared to the overall distance that the fluid flows through the head portion 20.

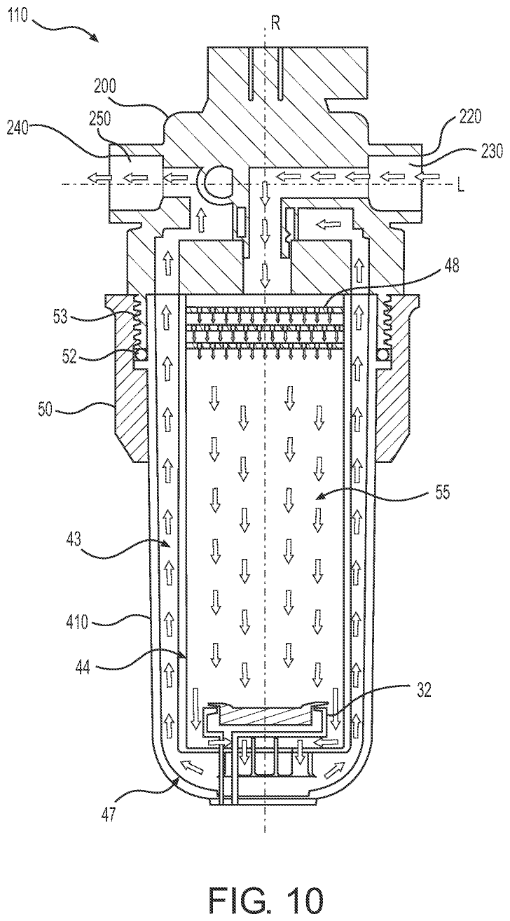

The fluid treatment apparatus 10 can include a longitudinal axis R roughly bisecting the fluid treatment apparatus 10 and extending in the lengthwise direction of the apparatus 10. The inlet 22 and the outlet 24 may be arranged on opposite sides of the longitudinal axis R, for example, such that D1 and D2 extend in the same direction and in a direction traverse to the longitudinal axis R. The inlet conduit 23 and the outlet conduit 25 are in fluid communication with the reactor vessel 40, and the reactor vessel 40 is configured to receive fluid at a downstream location with respect to the inlet conduit 23 and at an upstream location with respect to the outlet conduit 25. Thus, the fluid treatment apparatus 10 is configured so that the fluid generally flows through the inlet 22 and inlet conduit 23, then turns obliquely toward the reactor vessel 40 and passes through apertures 67 which direct the fluid into the reactor vessel 40. As described below, the fluid is treated in the reactor vessel 40 and then flows back into the head portion 20 and to the outlet conduit 25 and outlet 24 where it can exit the apparatus to another section of piping or plumbing. However, the direction of the fluid flow is not particularly limited, and, for example, as shown in FIG. 10, the direction of the fluid flow may be reversed.

Based on the configuration described in FIG. 1, and in a particular where the inlet conduit 23 and the outlet conduit 25 are co-linear, the apparatus 10 can be installed in-line onto an existing straight section of piping or plumbing. In such a case, the apparatus 10 can be installed inexpensively, quickly, and easily by cutting a section of the existing piping and connecting the inlet 22 and outlet 24 to the cut portions. This also prevents the need to install additional sections of plumbing to reach the inlet 22 and/or outlet 24, which saves space and eases installation onto existing household piping, where space is typically limited. In some embodiments, the inlet conduit 23 and outlet conduit 25 may incorporate inserts, such as metal inserts, to improve the durability of connections to, for example, the existing piping or plumbing.

The reactor vessel 40 has a length direction that extends in a direction transverse to D1 and D2 of the head portion 20. For example, the reactor vessel 40 may have a length direction that extends transverse to D1 or D2 at an angle in a range of 45° to 135°, a range of 60° to 120°, or a range of 75° to 105° for example.

The reactor vessel 40 can be removably attachable to the head portion 20, for example, by a threaded coupling. In the FIG. 1 embodiment, the reactor vessel 40 is removably attached to the head portion 20 via an adapter unit 30, which is described in more detail below. In other embodiments, the reactor vessel 40 can be directly removably coupled to the head portion 20 without the need for an adapter unit 30. In some embodiments, a body of the reactor vessel 40, for example including an outer vessel 42 and an inner vessel 44, is removably attachable to the head portion 20. By being removably attachable to the head portion 20 and extending in a direction transverse to D1 or D2, the reactor vessel 40 may be easily removed for maintenance, or parts replacement, for example, without having to uncouple the apparatus 10 from the plumbing. In some embodiments, the apparatus 10 may include a flow diversion valve. The flow diversion valve may divert a flow path of the apparatus, preventing the flow of the fluid from entering the reactor vessel 40. The flow diversion valve may also prevent flow from entering the adapter unit 30. For example, the flow diversions valve may divert the flow path directly from the inlet conduit 23 to the outlet conduit 25, bypassing the adapter unit 30 and the reactor vessel 40. Accordingly, the flow diversion valve may be activated for maintenance of the apparatus 10, such as when removing or attaching the adapter unit 30 and/or the reactor vessel 40.

The reactor vessel 40 may have a substantially cylindrical body defined by an outer vessel 42. For example, the reactor vessel 40 may have a circular cross-sectional shape, as shown in FIG. 1. However, the present disclosure is not limited to any particular cross-sectional shape, and the reactor vessel 40 may have various other cross-sectional shapes, for example, an elliptical shape, a polygonal shape including, for example, a square or rectangular shape, and a semicircular shape. The outer vessel 42 may comprise features such as ribs to facilitate gripping the vessel, for example, with a wrench to turn the reactor vessel to engage or disengage threads used to mount the reactor vessel.

The reactor vessel 40 includes an inner vessel 44. The inner vessel 44 may not be permeable to fluid from an exterior wall. The inner vessel 44 is housed within the outer vessel 42, and is spaced apart from an inner surface of the outer vessel 42 to define an outer volume 43 between the inner vessel 44 and the outer vessel 42. If the outer vessel 42 and inner vessel 44 have a substantially cylindrical, conical, or frusto-conical shape, the outer volume 43 may have an annular cross-sectional shape. The outer volume 43 defines a flow path for the fluid. The fluid treatment apparatus 10 is configured such that a flow path of the fluid from the inlet conduit 23 conveys fluid to the outer volume 43, e.g., through a flow path that extends through the head portion 20 and adapter unit 30 as shown in FIG. 1. In this embodiment, the outer volume 43 defines a flow path that surrounds the inner vessel 44, and the fluid flows substantially in a direction D3 that extends along a lengthwise direction of the reactor vessel 40. The fluid is then conveyed to a distal region 47 of the outer volume 43, where distal is defined with respect to the head portion 20, where it turns, following the contour of the outer vessel 42 and is directed toward an inlet 49 of the inner vessel 44. This inlet 49 may comprise one or more openings that may be substantially axial or radial relative to axis R. Once the fluid enters the inner vessel 44, it can pass through a flow diffuser 48, which is described in detail below, and then travels within the inner vessel 44 in direction D4 where it is treated with UV radiation.

When the head portion 20 is joined to the adapter unit 30 and/or the reactor vessel 40, the fluid may travel from the head portion 20 to the reactor vessel 40 by apertures 67. The apertures may be part of the head portion 20, the adapter unit 30, and/or the reactor vessel 40. The apertures may be arranged circumferentially, for example, around an outlet 35 of the reactor vessel 40. The apertures 67 may provide a flow path for the fluid from the inlet conduit 23 to the outer vessel 42 and may be in an arrangement that improves flow distribution for UV treatment.

In this embodiment, the inlet 49 of the inner vessel 44 is located about the longitudinal axis R of the reactor vessel 40 at a distal wall 51 of the inner vessel 44, where the distal is defined with respect to the head portion 20, and the inlet 49 has a smaller cross-section than a cross-section of an interior of the inner vessel 44. In this embodiment, fluid flowing through outer volume 43 extends beyond an outermost end of the inner vessel 44, opposite of the head portion 20, before entering the inlet 49 of the inner vessel 44. In some embodiments, fluid flowing through the outer volume 43 can traverse an entirety of an exterior surface 45 of the inner vessel 44 before entering the inlet 49 of the inner vessel 44. In some embodiments, the flow through the apparatus may be in the opposite direction. That is, the flow may enter through the outlet 35 and travel first through the inner vessel 44 before reaching the outer volume 43 and returning to the head portion 20.

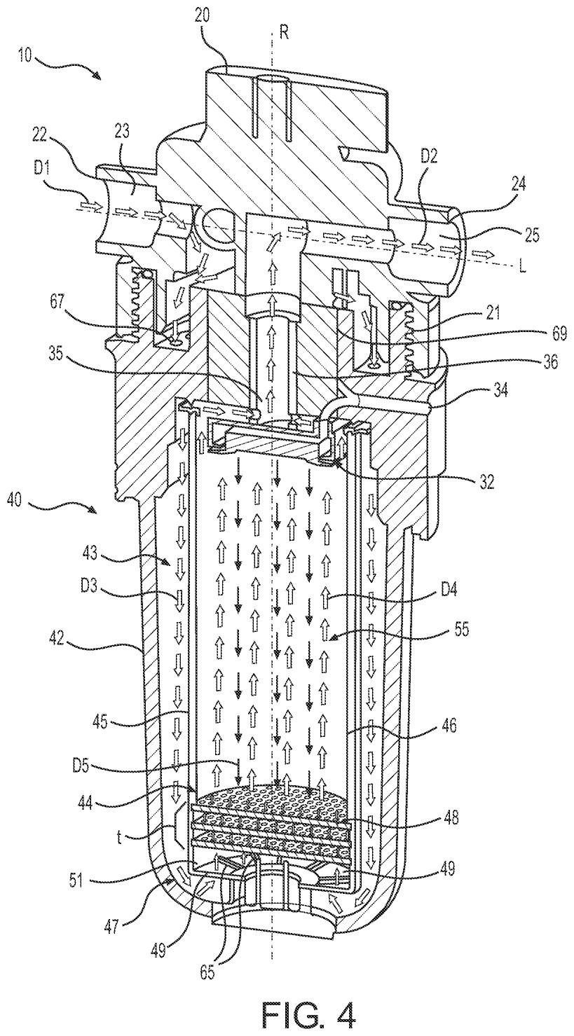

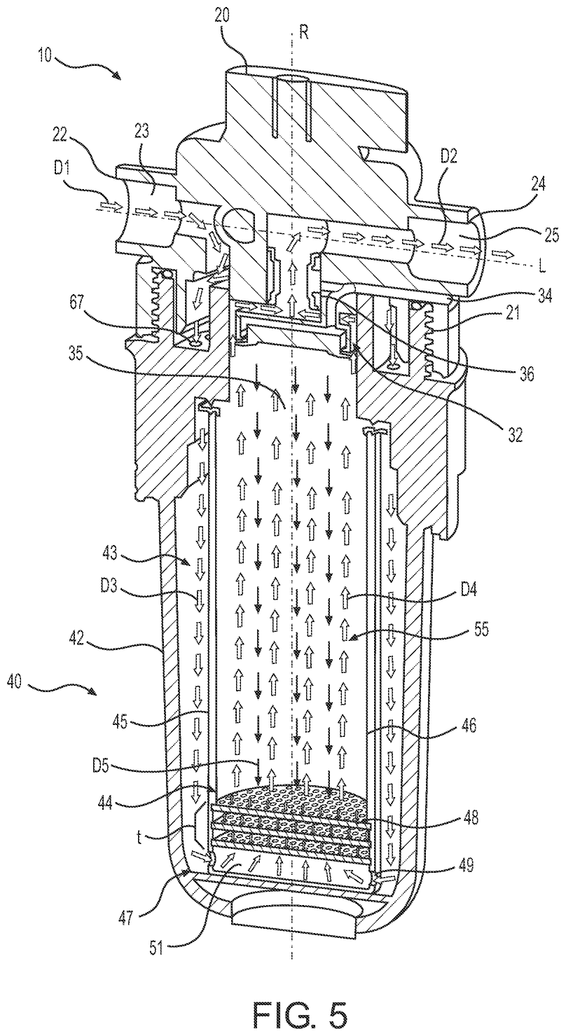

In some embodiments, as shown in FIG. 4, the inlet 49 of the inner vessel 44 comprises openings that are arranged in the distal wall 51 of the inner vessel 44 and are positioned radially offset from the longitudinal axis R. In this embodiment, the inlet 49 may have an outer diameter that is equal to the inner diameter of the inner vessel 44. Fins 65 may support a structure of the inner vessel 44, providing gaps for the fluid to enter through the inlet 49 into the inner vessel 44. In other embodiments, such as in FIG. 5, the inlet 49 of the inner vessel 44 can be positioned in the sidewall of the inner vessel 44 near the distal region 47 of the outer volume 43. In other embodiments, the inner vessel 44 can have an inlet that is entirely open at an end region of the inner vessel 44, and the fluid from the outer volume 43 can be directed to an inner volume 55 of the reactor vessel 40, e.g., near distal region 47.

The light source unit 32 can be arranged in the apparatus 10 to emit UV radiation into the inner volume 55 in a direction D5 that is aligned with a direction D4 of fluid flow within the inner vessel 44. “Aligned” in this context means that it has a directional component extending in the same direction or in opposite direction. In the FIG. 1 embodiment, the inlet 49 of the inner vessel 44 may be at an opposite side of the reactor vessel 40, in the lengthwise direction, than the light source unit 32, which emits UV radiation into the inner volume 55 in a direction D5 that is opposite to the direction D4 of fluid flow within the inner vessel 44. The light source unit 32 in FIG. 1 can also be angled with respect to the interior of the inner vessel 44 so that the direction D5 is facing the flow of fluid but transverse to the direction D4 (e.g., from 135° to) 225°. The positioning of the light source unit 32 near an outlet 35 of the inner vessel 44 and such that the UV radiation emitted from the light source unit 32 is substantially opposite to the flow of the fluid, may provide superior germicidal efficacy. However, the present disclosure is not limited to this, and the light source unit 32 can be positioned in any suitable orientation for sufficiently treating the fluid flowing through the inner vessel 44 with UV radiation. For example, in other embodiments, the inlet 49 of the inner vessel 44 and the light source unit 32 can be located on the same side of the reactor vessel 40, for example on the distal end of the reactor vessel 40 with respect to the head portion 20, where the light source unit 32 emits UV radiation into the inner vessel 44 in the same direction as the fluid flow within the inner vessel 44, or alternatively at a transverse angle (e.g., from +/−) 45°.

The present disclosure is not limited to a single light source unit 32 and the light source unit 32 described herein shall be understood as at least one light source unit 32. For example, in some embodiments, the light source unit 32 may comprise multiple light sources and/or multiple light source units positioned at the same or at different ends of the reactor vessel 40, facing the same or facing different directions with respect to the longitudinal axis R of the reactor vessel 40. In other embodiments, the reactor vessel 40 can be provided with a first light source unit 32 at one side of the inner vessel 44 in a lengthwise direction and a second light source unit 32 at the opposite side of the inner vessel 44, so that the two light source units face each other and emit UV radiation in opposite directions to treat the fluid. In other embodiments, the light source unit can extend in the inner vessel 44 and emit UV radiation radially within the inner vessel 44. For example, in some embodiments, the light source unit 32 may be a stick lamp extending in the reactor vessel along longitudinal direction R of the reactor vessel 40 and emitting UV radiation radially outwardly. For example, the light source unit 32 may extend from an outlet 35 of the inner vessel 44 to an inlet 49 of the inner vessel 44 or any fraction of such distance. In other embodiments, the light source unit 32 may be attached to an interior surface 46 of the inner vessel 44 and emit UV radiation radially inwardly in the inner vessel 44.

The light source unit 32 can be mounted on adapter unit 30 or on the inner vessel 44 of the reactor vessel, or on the head portion 20. The light source unit 32 can be positioned adjacent to an outlet 35 of the inner vessel 44 where the fluid exits the inner vessel 44, or near an inlet 49 of the inner vessel 44. The light source unit 32 can extend into the inner vessel 44 or can be positioned at or near an intersection of the adapter unit 30 and the inner vessel 44 as long as the light source unit 32 can emit UV radiation into the inner vessel 44. A cross-sectional area of one of the light source unit 32, taken on a plane orthogonal to the longitudinal axis R of the reactor vessel 40, can be from 25%-90% of the cross-sectional area of the inner vessel 44, from 30%-75% of the cross-sectional area of the inner vessel 44 or from 35%-60% of the cross-sectional area of the inner vessel 44.

The light source unit 32 may be positioned in a flow path of the fluid, such that the fluid cools the light source unit 32. For example, the light source unit 32 may be arranged so as to be partially or fully immersed in the fluid flowing through the reactor vessel 40. In other words, the fluid flowing through the reactor vessel 40 impinges on and flows around the light source unit 32. The fluid not only impinges on the front, light-emitting side of the light source unit 32, but may also impinge on and flow around a side and a back side of the light source unit 32, where considerable heat is often generated. The back side may be opposite of the light emitting front side. Thus, the fluid being treated can be used to continuously cool the light source unit 32. Cooling of a light source in a conventional UV fluid treatment system may be difficult, considering the excessive heat often generated by the light source and related electrical components. Thus, the present disclosure advantageously prevents excessive heating of the light source unit 32 which prevents a decrease in radiation output and decrease in the useful lifetime of the light source unit 32. The light source unit 32 may incorporate features such as fins to increase heat transfer, and the outlet 35 may be configured to increase heat transfer via the use of nozzles or other features.

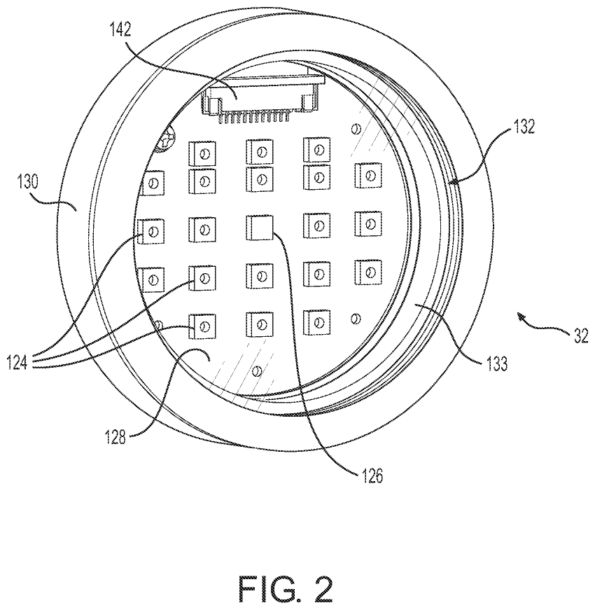

As shown in FIG. 2, the light source unit 32 can have a disc or puck shape that can be mounted in the reactor vessel, e.g., on the inner vessel 44 or on the adapter unit 30, or in the head portion 20, for example. The light source unit 32 can have an array of a plurality of light sources, in this case UV LEDs 124, that are mounted on and electrically coupled to a circuit board 128, such as a printed circuit board (PCB) or a metal core printed circuit board (MCPCB). The circuit board 128 may be inset inside a housing 130 and include an electrical connector 142. A plane of the circuit board 128 may be oriented parallel to the width dimension of the light source unit 32 and the housing 130. The housing 130 may be ideally made of a heat-conductive material to facilitate heat conduction from the LEDs to the fluid being treated. The UV LEDs 124 may be arranged in any suitable pattern on the circuit board 128. The number of UV LEDs 124 arranged in the light source unit 32 may be determined based on the flow rate and/or level of disinfection. In one example, the light source unit 32 may include a number of UV LEDs 124 in a range of 5 to 100, a range of 15 to 50, or a range of 10 to 30. The circuit board 128 may include a metal backing or metal core made of a heat-conductive material, such as copper, aluminum, and alloys thereof, in order to facilitate conducting heat away from the light source unit 32. The printed circuit may contain conductive metal (e.g. copper) pathways, commonly known as “vias” to conduct heat from the LEDs through the printed circuit board to facilitate heat transfer to the back of the light source unit and thereby into the fluid. For example, the heat generated by the light source unit 32 can be dissipated to the fluid being treated through the heat-conductive backing or core and the heat-conductive housing 130. The heating-conductive backing on the circuit board 128 may be in direct contact with the thermally-conductive back of the housing 130 to facilitate heat dissipation to the fluid. Alternatively, a heat-conducting paste, pad, or solder may be used to conduct heat from the circuit board 128 to the housing 130. The light source unit 32 may include a sensor 126, which may detect, for example, a temperature of the light source unit 32 or an intensity of UV radiation. This intensity sensor may directly monitor UV emitted by the LEDs, or may monitor UV that is reflected to the sensor by surfaces of the inner vessel 44 or of the light source unit 32. The sensor 126 may measure and detect malfunctioning or needs of service or maintenance, including cleaning or removing fouling materials, of the light source unit 32 or reactor vessel 40.

The UV LEDs in the light source unit 32 may emit light in the UV spectrum, for example, in a wavelength band of about 100 nm to about 405 nm, a wavelength band of about 200 to about 330 nm, or a wavelength band of about 250 nm to about 300 nm. The UV light in the above wavelength bands has high germicidal efficacy and may kill at least 99% of microorganisms, such as bacteria, fungi, viruses, mold, and the like, in the fluid, making the fluid safe for use and consumption. The light source unit 32 may have an efficiency in converting electrical energy to UV light energy in a range of about 3% to about 30%, a range of about 4% to about 15%, or a range of about 5% to about 10%. The apparatus 10 may be designed to deliver a UV dose of 5 mJ/cm² to 100 mJ/cm², or about 30 mJ/cm², to the fluid at a target flow rate and target water quality, or may be designed to deliver any other suitable UV dose to the fluid.

The light source unit 32 may include optical elements to optimize the light distribution reaching the fluid. Those elements could comprise: a window 132 that has one or more curved surfaces; individual lens or lens assemblies associated with each LED source; a parabolic or other curved reflector associated with each LED source; a parabolic or other curved reflector associated with the entire LED assembly; and/or a device configured to reflect light, for example, a parabolic reflector or a reflective coating material, including any configuration described below with respect to the inner vessel 44 configured to reflect light. The window 132 may be made of any suitable material such as fused silica, sapphire, or a fluoropolymer. The housing 130 may be waterproof. The window 132 may be provided with seals to prevent water ingress. The light source unit 32 may comprise a reflective ring around the internal perimeter 133 of the assembly to reflect photons that would otherwise be absorbed by the interior circumferential wall of the light source unit 32. The perimeter of the window 132 may incorporate a reflective surface either coated onto the surface or positioned adjacent the perimeter surface. The optical elements may comprise a reflective material coated or mounted on the surface of the circuit board 128. The light source unit 32 may also include a cable or an electrical connector to allow the light source unit 32 to be disconnected from any associated power and signal wiring. The light source unit 32 may include external features such as tabs, mounting holes, mounting posts, or other features to facilitate mechanical attachment to the reactor vessel 40.

In some embodiments, the light source unit 32 may primarily emit UV radiation in a direction that is aligned with the direction of fluid flow within the inner vessel 44, such as direction D4. “Primarily” in this context means the light source unit emits over 50%, over 80%, over 90%, or over 95% of its UV radiation in a direction aligned with the direction of fluid flow within the inner vessel 44. The position of the light source unit 32, a shape of the light source unit 32, such as a disc or puck shape as shown in FIG. 2, and the optical elements previously described, for example the parabolic or curved reflector, may direct the UV radiation into a direction aligned with the fluid flow. By primarily emitting UV radiation into a direction aligned with a flow direction of the fluid, such as direction D4, the light source unit 32 may provide superior germicidal efficacy, for example, by increasing a path length of the UV radiation. The path length of the UV radiation may be a distance traveled by the UV radiation from the light source unit 32 before reaching an opposite end of the inner vessel 44 or reaching a material that substantially reflects or absorbs the UV radiation. In some embodiments, the path length may be over 50%, over 80%, over 90%, or over 95% of the length of the inner vessel 44, where the length of the inner vessel extends in a direction from the head portion 20 a distal end of the inner vessel 44, opposite of the head portion 20.

Referring again to FIG. 1, the inner vessel 44 may be constructed to reflect light that reaches its interior surface 46. This could be accomplished by having a highly polished interior surface 46, by constructing the inner vessel 44 with a material such as Teflon™ that can reflect a majority of light, or by coating the interior surface 46 with a reflective liner, configured to reflect UV radiation emitted by the light source unit 32. The reflective liner may be made of any suitably reflective material, such as polytetrafluoroethylene (PTFE), aluminum, stainless steel, or the like.

In some embodiments, the inner vessel 44 may be constructed of a UV-transparent material such as fused silica (“quartz”) and include a reflective material, such as the reflective liner, on the exterior surface 45. The reflective material may be a metallic coating such as aluminum, a material such as Teflon™, or a material with a lower refractive index to induce total internal reflection at the interface between the reflective material and the exterior surface 45. In some embodiments, there may be an overlayer or a protective coating over the reflective material, protecting the reflective material from a fluid in the outer volume 43. The overlayer or protective coating may be, for example, epoxy, enamel, ceramic, or any other material suitable for water contact. Advantageously, the quartz may be highly inert to water contact, such that the interior surface 46 will not react with fluid passing through the inner volume 55. UV radiation emitted from the light source unit 32 may pass through the quartz and be reflected back through the quartz to the fluid flowing in direction D4.

The reflection of UV radiation may prevent most of the UV radiation from reaching the reactor vessel 40. Accordingly, the reactor vessel 40, including the inner vessel 44 and the outer vessel 42, may be composed of plastic. For example, at least 60%, at least 80%, at least 90%, or at least 95%, by weight, of the reactor vessel 40 may be composed of plastic, including plastics that are degradable by UV light such as polyvinyl chloride, polycarbonate, polypropylene, etc. The head portion may further be composed of plastic.

A flow diffuser 48 may be positioned adjacent to the inlet 49 of the inner vessel 44, for example, at the inlet 49, upstream of the inlet 49, downstream of the inlet 49, at a proximal end of the reactor vessel 40, or at a distal end of the reactor vessel 40, proximal and distal being in respect to the head portion 20. The flow diffuser 48 may discharge fluid into the inner vessel 44. The flow diffuser 48 may be configured to distribute the fluid flow across a cross-section of the inner vessel 44, for example in the direction D4, so that the fluid flow within the inner vessel 44 is more uniform or to more closely match an intensity profile produced by the light source unit 32. The flow diffuser 48 may also regulate a flow of the fluid, and typically reduces the velocity of the fluid flow. The flow diffuser 48 may be formed of a UV resistant material such as ceramic or metal. The flow diffuser 48 may be constructed of a material that reflects the majority of UV light reaching it, so that the UV may pass back through the inner volume 55, achieving additional disinfection.

In some embodiments, the flow diffuser 48 may act as a light lock that prevents substantially all of the UV radiation (e.g., at least 90% or at least 95%) that impinges on the flow diffuser 48 from escaping or leaving the inner vessel 44 while simultaneously enabling fluid to flow through the flow diffuser 48. For example, the flow diffuser 48 may be a series of ball bearings or spheres, a layer of thread such as carbon floss, or a labyrinth configured to prevent UV radiation or light from escaping while simultaneously allowing the flow of a fluid. This can be accomplished, e.g., by causing the fluid to flow in crooked/tortuous paths within the flow diffuser. As shown in FIG. 1, the flow diffuser 48 is a series of grids and has a thickness t extending in a lengthwise direction of the inner vessel 44. Each grid includes a plurality of apertures through which fluid flows. The apertures in each grid are offset with respect to an adjacent grid, such that UV radiation traveling in a straight line along direction D5 and traveling through the apertures of one grid will not travel through apertures of the next grid. By using the flow diffuser 48, substantially all of the UV radiation impinging on the flow diffuser may be prevented from exiting the inner vessel 44. In a conventional UV radiation treatment system, the UV radiation may damage or degrade a plastic component of the system, such as a housing for the UV light source. This may result in maintenance of the system, such as replacing the damaged piece. It may even result in contamination of the treated water with plastics. Providing a flow diffuser acting as a light lock, for example in combination with the inner vessel 44, enables components of the fluid treatment apparatus 10, such as the head portion 20, adapter unit 30, and reactor vessel 40, to be composed of a plastic which would otherwise degrade in a conventional UV treatment system by repeated exposure to the UV radiation.

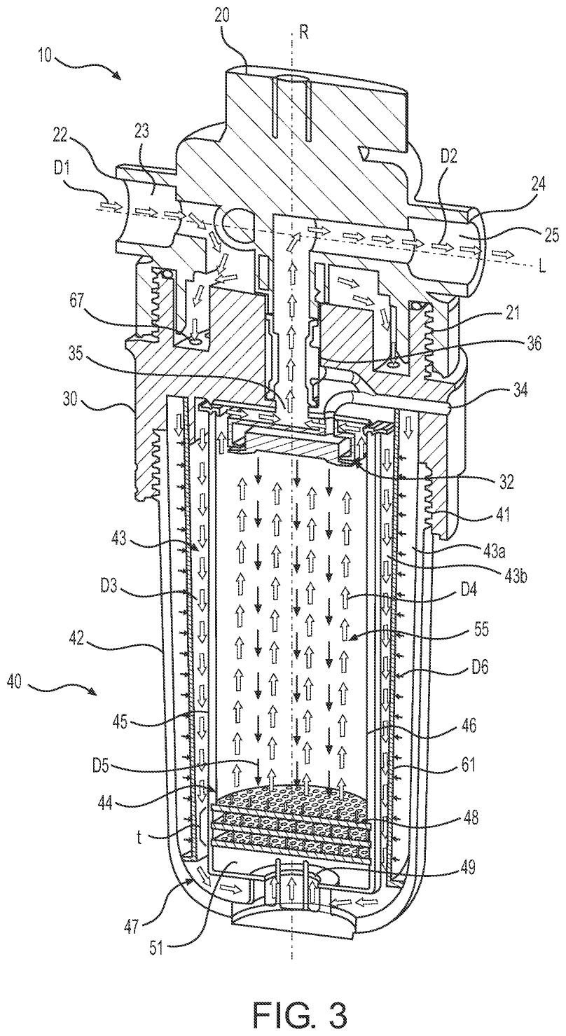

FIG. 3 shows an embodiment of the fluid treatment apparatus with a filter 61. As shown in the FIG. 3, the filter 61 extends axially along an exterior surface 45 of the inner vessel 44, dividing the outer volume 43 into an outer region 43a and an inner region 43b. After entering the inlet conduit 23, the fluid flows into the outer region 43a and then flows in a radial direction D6, permeating the filter 61 and entering the inner region 43b. In this configuration, the fluid must pass through the filter 61 in order to enter inner region 43b. The fluid then flows along D4 to the distal region 47 following the contour of the outer vessel 42 and is directed toward the inlet 49 of the inner vessel 44 to the inner volume 55, where it may be irradiated by the light source unit 32. The filter 61 is not limited to this configuration and may be included, for example, anywhere in the reactor vessel 40 at some point along the flow path to capture particles that may be suspended in the fluid. The filter 61 may be positioned, as shown in FIG. 3 upstream of the inlet 49, or downstream of the inlet 49. The filter 61 may be, for example, a mechanical (particle), a chemical or biological filter, an activated carbon filter, or any other type of filter of filter media.

As shown in FIG. 1, the head portion 20 can be removably attachable to the reactor vessel 40 by an adapter unit 30. In this regard, the adapter unit 30 can be considered to be a connection portion of the reactor vessel 40 that connects the reactor vessel 40 to the head portion 20. The adapter unit 30 includes a first threading 21 that is configured to threadedly engage corresponding threading on the head portion 20. Alternatively, the head portion 20 and the adapter unit 30 may include other connecting mechanisms suitable for positioning and detachably connecting the units. In some embodiments, the connection may be a friction fit or a waterproof coupling for example, facilitated by an O-ring or a gasket. A second threading 41 is configured to threadedly engage the adapter unit 30 and the outer vessel 42. Alternatively, the adapter unit 30 and the reactor vessel 40 may include other connecting mechanisms suitable for positioning and detachably connecting the units. In some embodiments, the connection may be a friction fit or a waterproof coupling for example, facilitated by an O-ring or a gasket. In some embodiments, the adapter unit 30 may be permanently joined or affixed to the reactor vessel 40, or outer vessel 42, forming a unitary piece that is part of the reactor vessel 40. In other embodiments, the adapter unit 30 can be omitted. In some embodiments, the reactor vessel 40 can be removably attachable directly to the head portion 20, e.g., with a simple connection portion that may only include threading or other connecting mechanisms, as shown in FIGS. 4 and 5 described below.

By providing the adapter unit 30, for example with a first threading 21 and a second threading 41, the fluid treatment apparatus 10 may be easily disassembled, making components within various units of the fluid treatment apparatus 10 accessible for maintenance. In addition, the multiple threadings 21, 41 ensure the assembly may be disassembled should one threading lock up or jam. The adapter unit 30 may further include sealing elements, such as O-rings or gaskets to create a water-tight seal between the adapter unit 30 and the head portion 20 and/or the adapter unit 30 and the reactor vessel 40.

As shown in FIG. 1, the light source unit 32 can be mounted on the adapter unit. The adapter unit 30 may also include a flow sensor 36. The flow sensor 36 may measure a flow rate of the fluid traveling through the apparatus 10. A controller can receive signals from the flow sensor, intensity sensor, or temperature sensor, and use this information to adjust the electrical power supplied to the light source unit 32. An amount of power supplied to the light source unit 32 may be adjusted based on the measured flow rate. For example, if a low flow rate is measured, the amount of power supplied to the light source unit 32 may be reduced to extend the life expectancy of the light source unit 32. Conversely, if a high flow rate is measured, the power supplied to the light source unit 32 may be increased to ensure adequate treatment of the fluid by the light source unit 32. Flow signals, such as detection of continuous non-zero flow, may also be used as an indication of leakage within a system, such as in a home.

The adapter unit 30 may include an electrical wiring 34 or may include an aperture for the installation of the electrical wiring 34. The electrical wiring 34 may supply power or a communication signal to the light source unit 32 and/or to the flow sensor 36. The electrical wiring 34 may be configured to connect the light source unit 32 and/or the flow sensor 36 to, for example, a DC or an AC power supply. The adapter unit may include a connector to allow the electrical wiring to be readily disconnected.

By providing electrical components 32, 34, 36 in the adapter unit 30, the electrical components 32, 34, 36 can be easily accessed for maintenance by detaching the adapter unit 30 from the head portion 20 and/or the reactor vessel 40. Further, by providing the electrical components 32, 34, 36 in a unit separate from the reactor vessel 40 and the head portion 20, the electrical components may positioned to protect them from fluid which can damage the components. The controller and power supply may be positioned outside the reactor vessel 40 to protect them from damage and provide information through an external display.

FIG. 4 shows an embodiment where the reactor vessel 40 is directly coupled with and removably attachable to the head portion 20 by threadings 21. The light source unit 32, the flow sensor 36, and the electrical wiring 34 may be formed as part of, housed in, or mounted on the reactor vessel 40. In FIG. 4, the flow sensor 36 is mounted on the light source unit 32 and is configured such that the fluid traverses across the light source unit 32 and enters the flow sensor 36. The reactor vessel 40 may include a removable portion 69. In FIG. 4, the flow sensor 36 is included in the removable portion 69, and the light source unit 32 is mounted on the removable portion 69. When the reactor vessel 40 is detached from the head portion 20, the removable portion 69 may be removed from the reactor vessel 40 for access to components such as the inner vessel 44, the electrical wiring 34, the flow sensor 36, the flow diffuser 48, and/or the light source unit 32, such as for maintenance. The removable portion 69 is not particularly limited in size and may be large enough to accommodate removal of the inner vessel 44. The removable portion 69 may be attached to the reactor vessel 40 by a threading, not shown, by an interference fit or by any other suitable means. The removable portion 69 may further include fluid sealing elements such as an O-ring. In some embodiments, the reactor vessel 40 may include a provision for providing electrical power to the light source unit 32, and for sending signals from the light source unit 32 and its sensor(s) to the controller. This provision may include electrical wiring 34, connectors, and the like. The reactor vessel 40 may also include an external power supply and an external controller. The external power supply is not particularly limited and may include, for example, a power supply with an alternating current or a direct current. In some embodiments, for example, the power supply may be power grid or a battery.

FIG. 5 shows an embodiment where the light source unit 32 is mounted on the head portion 20. The light source unit 32, the flow sensor 36, and the electrical wiring 34 may be formed as part of, housed in, or mounted on the head portion 20. Accordingly, the reactor vessel 40 may be removably detached for access to components such as the inner vessel 44, the electrical wiring 34, the flow sensor 36, the flow diffuser 48, and/or the light source unit 32, such as for maintenance. In some embodiments, the inner vessel 44 may be removed from the reactor vessel 40 when in a detached state. In some embodiments, the head portion 20 may include a provision for providing electrical power to the light source unit 32, and for sending signals from the light source unit 32 and its sensor(s) to the controller. This provision may include electrical wiring 34, connectors, and the like. The head portion 20 may also include an external power supply and an external controller.

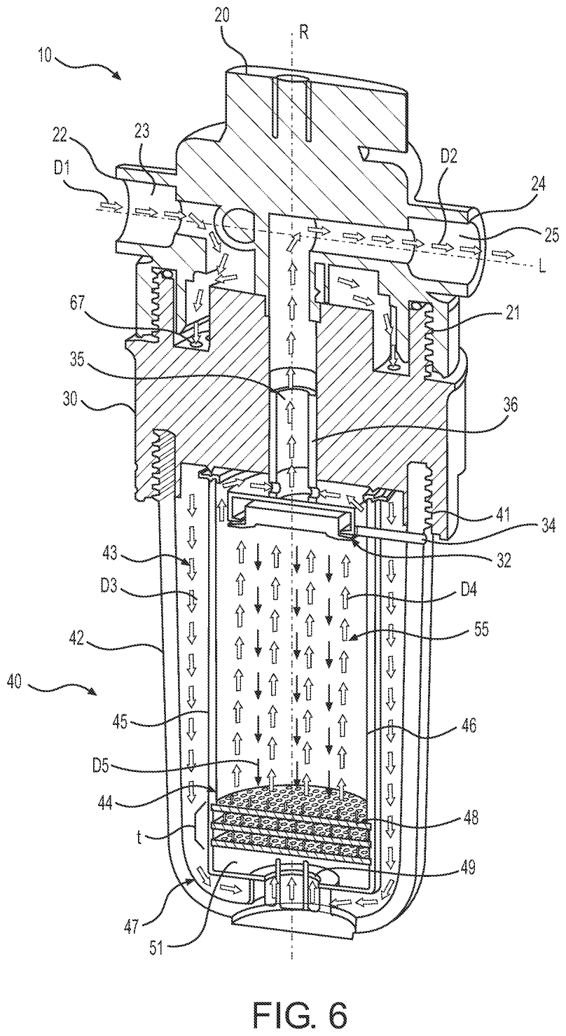

FIG. 6 shows an embodiment where the light source unit 32, the flow sensor 36, and the electrical wiring 34 is included in the reactor vessel 40. The light source unit 32 is mounted on the reactor vessel 40, and the flow sensor 36 is mounted to the light source unit 32. The light source unit 32, the flow sensor 36, and the electrical wiring 34 may be formed as part of, housed in, or mounted on the reactor vessel 40. Accordingly, the adapter unit 30 may be removably detached from the reactor vessel 40 for access to components such as the inner vessel 44, the electrical wiring 34, the flow sensor 36, the flow diffuser 48, and/or the light source unit 32, such as for maintenance. The reactor vessel includes a provision for transmitting electrical power and signals between the light source unit 32 and its sensor(s) to the controller. The reactor vessel 40 may include electrical wiring 34, connectors, and the like. The reactor vessel 40 may also include an external power supply and an external controller.

As shown in FIG. 6, the flow sensor 36 has a spool shape. The flow sensor is joined to the reactor vessel 40, for example, directly coupled with the light source unit 32. When the reactor vessel 40 is removably attachable to the adapter unit 30, and, when in an attached configuration, the flow sensor 36 is inserted into the adapter unit 30. In some embodiments, the flow sensor 36 may be inserted into the head portion 20, for example, when the reactor vessel 40 joins directly to the head portion 20. The flow sensor 36 may be powered by the electrical wiring 34, provided through the reactor vessel 40. The flow sensor 36 is depicted schematically and may include components not pictured, such as a turbine, a force sensor, a thermometer, a pressure sensor, or other components. The flow sensor is not particularly limited and may include embodiments, such as other than a spool.

In some embodiments, the reactor vessel 40 and/or the adapter unit 30 can be retrofit onto an existing head portion. For example, an existing head portion may already be installed in a piping system that is part of a water filtration system that was designed to convey water flow through another water treatment component. The reactor vessel 40 and/or the adapter unit 30 may be configured to removably attach to such an existing head portion. The reactor vessel 40 and/or the adapter unit 30 may also be configured to form a continuous fluid conduit with the inlet and outlet conduits of the existing head portion, by coupling the flow path in the reactor vessel 40/adapter unit 30 with the corresponding flow paths in the existing head portion. Thus, when installed on the existing head portion, a flow path is configured to enter the head portion at an inlet of the head portion, flow through the reactor vessel for UV treatment and optional filtration, and flow back into the head portion to discharge from the head portion at an outlet of the head portion.

The reactor vessel 40 and/or the adapter unit 30 may be removably attachable to the installed head portion and utilized to treat fluid with UV radiation, for example, with an already installed head portion that was not originally intended for or purposed for treatment with UV radiation. For example, the existing head portion may be a head portion of a water filtration system. Such head portions are commonly called “caps” in the field of residential filtration systems, and are available from vendors such as Culligan™, Pentair™, and others. These head portions are available with or without flow diversion valves, pressure relief valves, and the like. A system for retrofitting onto the existing head portion may comprise the reactor vessel 40 which is configured to removably attach directly onto the existing head portion. In other embodiments, the system may comprise the adapter unit 30 which is configured to removably attach onto the existing head portion and the reactor vessel 40 may removably attach directly onto the adapter unit 30. For example, various adapter units 30 may be manufactured with various specifications configured to fit a variety of predetermined sizes for existing head portions while a single sized reactor vessel 40 may be manufactured to fit onto the various adapter units 30. Alternatively, the reactor vessel 40 may be manufactured with various specifications configured to fit a variety of predetermined sizes for existing head portions. In some embodiments, the outer vessel 42 may be an outer vessel from an existing filtration system and components, including but not limited to the inner vessel 44, the light source unit 32, and the flow diffuser 48, may be inserted into the existing filtration system.

In one embodiment, the fluid treatment apparatus 10 may be used in a residential environment for disinfecting water for household use. The apparatus 10 may be installed between a water source, such as a well or municipal water facility, and the point of household use. The apparatus 10 may be installed along a section of piping near the entry point of the house. For example, the apparatus 10 may be installed so as to be integrated with the household piping in the basement of a home at a position where the water flowing from external piping in fluid communication with a well or water treatment facility enters the home. The inlet 22 may receive water flowing from the water source, the reactor vessel 40 may treat the water with UV radiation, making the water safe for use, and the outlet 24 may discharge the treated water to downstream household piping for household use. For residential systems, the reactor vessel 40 can have a volume that is in a range of about 0.25 L to 10 L, from 0.5 L to 5 L, or from 1 L to 3 L, for example. By way of example, when used in a residential system, the apparatus 10 may be designed for a flow of fluid, such as water or other aqueous fluids (e.g., fluids including at least 75% or at least 95% water), through the reactor vessel 40 at a flow rate in a range of 1 to 25 gallons per minute (gpm), 5 to 20 gpm, or 10 to 15 gpm. Of course, at times, the fluid in the reactor vessel 40 may be substantially stagnant, in which case the flow rate may be less than 1 gpm, less than 0.5 gpm, or less than 0.25 gpm. The fluid treatment apparatus 10, however, is not limited to use in a residential system, and may be used in other systems, such as industrial or municipal systems. In that case, the volume of the reactor vessel 40 and/or the flow rate of fluid through the reactor vessel 40 may be higher.

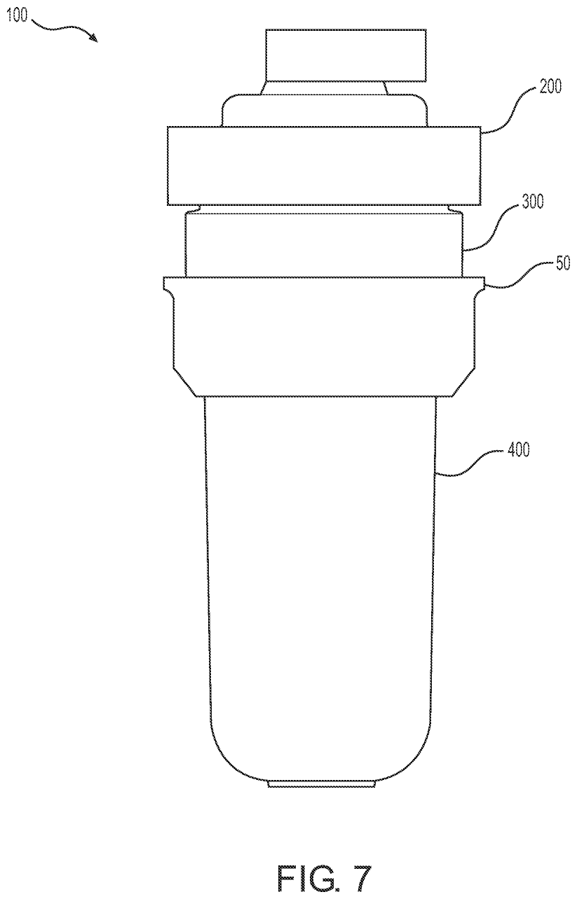

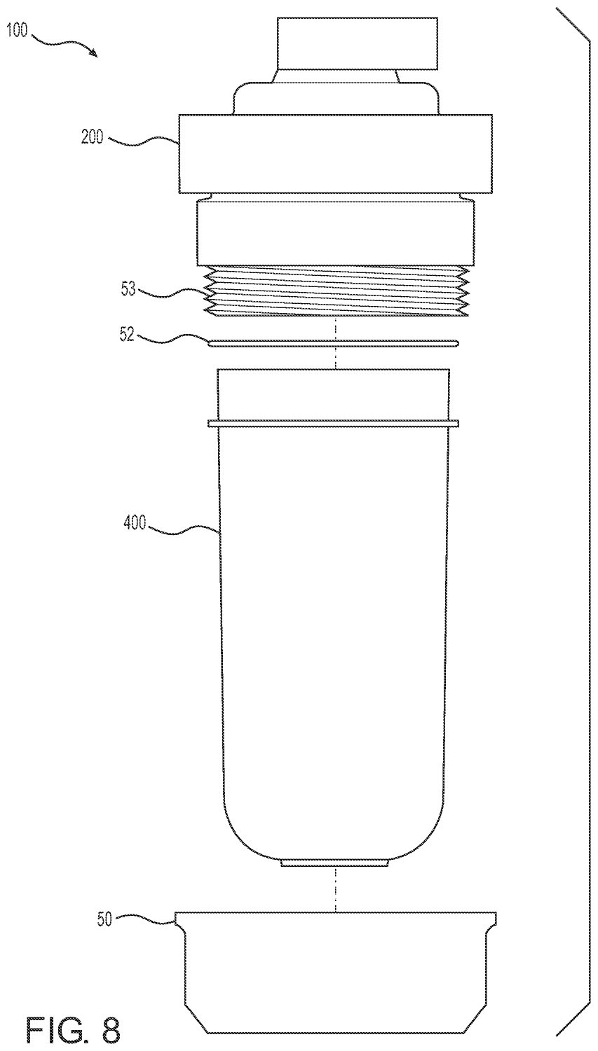

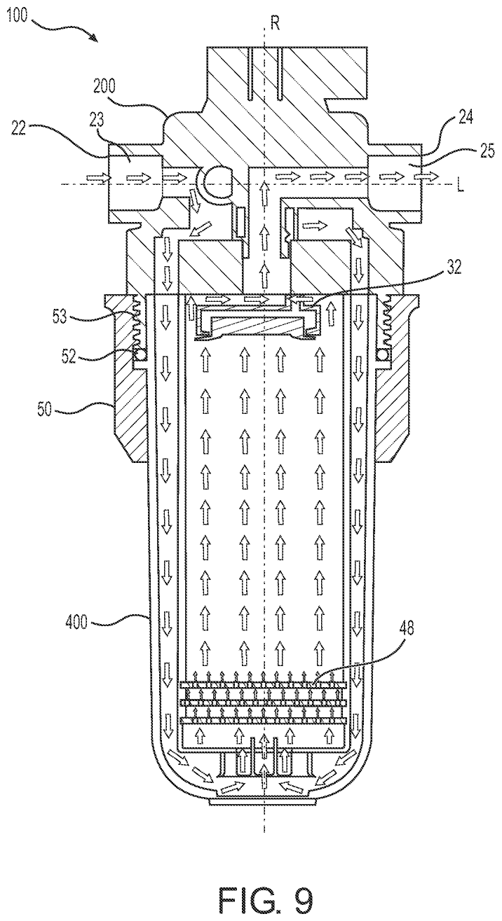

FIGS. 7-9 show an embodiment of a fluid treatment system 100 with a retaining ring 50. The fluid treatment system 100 includes a second embodiment of a head unit 200 and a second embodiment of a reactor vessel 400. In this embodiment, the head unit and the adapter unit form a unitary piece. In some embodiments, the adapter unit may be included and removably attachable to the head unit 200, for example by a threaded connection.

The retaining ring 50 is removably attachable to the reactor vessel by positioning the retaining ring 50 around an outer perimeter of the reactor vessel 400. The retaining ring 50 is configured to threadedly engage the reactor vessel 400, by positioning the retaining ring 50 on an outer perimeter of the head unit 200, to the head unit 200 via an retaining ring threading 53. Thus, the retaining ring 50 joins and seals the reactor vessel 400 to the head unit 200 by a threaded connection. An O-ring 52 fits between the head unit 200 and the reactor vessel 400, forming a water-proof seal between the units. Additional sealing elements, such as O-rings or gaskets, may create a water-tight seal between the head unit 200 and the reactor vessel 400.

By removably attaching the reactor vessel 400 to the head unit 200 by the retaining ring 50, the retaining ring 50 effectively prevents the retaining ring threading 53 from locking up or jamming, which enables disassembly of the fluid treatment system 100 without damaging the system.

As shown in FIG. 7, the light source unit 32 is permanently joined to the head unit 200 and is positioned within the reactor vessel 400 when the retaining ring 50 seals the reactor vessel 400 to the head unit 200. However, the light source unit 32 and other electrical components may instead be permanently fixed to the reactor vessel 400 or to a removably attachable adapter unit positioned between the head unit 200 and the reactor vessel 400.

The reactor vessel 400 may be configured to retrofit onto an existing head unit 200, as described above, or by the retaining ring 50. For example, retaining ring 50 may removably attach an existing head unit to the reactor vessel 400 and to form the continuous fluid conduit with the existing head unit. For example, various retaining rings 50 may be manufactured with various specifications configured to fit and seal the reactor vessel 400 to a variety of predetermined sizes for existing head units.

In some embodiments, the adapter unit 30 may act as or may be incorporated into the retaining ring 50. For example, the retaining ring 50 may include electrical components 32, 34, and 36 while engaging the reactor vessel 400 to the head unit 200 by a threaded connection. The retaining ring 50 may also be configured to removably attach to either the head unit 200 or the reactor vessel 400.

FIG. 10 shows an embodiment of a fluid treatment system 110 for treating fluid when the flow path of the fluid through the system is reversed from the above-described embodiments. As shown in FIG. 10, fluid flows into the head unit 200 through the inlet 220 and the inlet conduit 230, into a reactor vessel 410 where it first flows through the inner vessel 44 and then impinges on and flows around the light source unit 32. The fluid then exits the inner vessel 44 at the distal region 47 of the outer volume 43, flows through the outer volume 43 toward the head unit 200, and then flows back into the head unit 200 to the outlet conduit 250 and exits at outlet 240, where it can flow through another section of piping or plumbing.

In the reactor vessel 410, the flow diffuser 48 can be positioned at a proximal end of the reactor vessel 410, and the light source unit 32 can be positioned at a distal end of the reactor vessel 410, where the proximal and distal orientations are relative to the head unit 200. However, the positioning of the flow diffuser 48 and the light source unit 32 is not particularly limited.

Although embodiments disclosed herein have been described with respect to treating water with UV radiation treatment, the present disclosure is not limited to water, and may be used to treat any fluid, including liquids, vapors, gels, plasmas, and gases. Similarly, the present disclosure is not limited to residential UV treatment systems, and may be applied to industrial, municipal, and commercial systems.

The controller includes hardware, such as a circuit for processing digital signals and a circuit for processing analog signals, for example. The controller may include one or a plurality of circuit devices (e.g., an IC) or one or a plurality of circuit elements (e.g., a resistor, a capacitor) on a circuit board, for example. The controller may be a central processing unit (CPU) or any other suitable processor. The controller may be or form part of a specialized or general purpose computer or processing system. One or more controllers, processors, or processing units, memory, and a bus that operatively couples various components, including the memory to the controller, may be used. The controller may include a module that performs a method described herein. The module may be programmed into the integrated circuits of the processor, or loaded from memory, storage device, or network or combinations thereof. For example, the controller may execute operating and other system instructions, along with software algorithms, machine learning algorithms, computer-executable instructions, and processing functions of the fluid treatment system. The controller may include screens or LEDs to communicate system status, and may incorporate wireless transmitters to communicate system status information via Bluetooth, WiFi, or other protocols.

The controller may be operational with numerous other general purpose or special purpose computing system environments or configurations. Examples of well-known computing systems, environments, and/or configurations that may be suitable for use with the disclosed embodiments may include, but are not limited to, personal computer systems, server computer systems, thin clients, thick clients, electronic personal assistants, handheld devices, such as tablets and mobile devices, laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. An apparatus for treating fluid with ultraviolet (UV) radiation, the apparatus comprising:
a head portion including:
an inlet conduit that is configured to receive fluid entering the apparatus at an inlet and convey the fluid away from the inlet along an inlet direction of the inlet conduit; and
an outlet conduit that is configured to convey the fluid along an outlet direction of the outlet conduit toward an outlet, wherein the inlet direction and the outlet direction are co-linear;
a reactor vessel coupled to the head portion, the reactor vessel including:
an outer vessel;
an inner vessel housed within the outer vessel; and
an outer volume formed between the inner vessel and the outer vessel and defining a flow path which receives the fluid at a position downstream of the inlet conduit and upstream of the outlet conduit, and is configured to convey the fluid along a first direction toward an inlet of the inner vessel, wherein the fluid then flows within the inner vessel along a second direction that is transverse to the inlet direction and the outlet direction;
an LED light source unit configured to emit UV radiation into the inner vessel, wherein the LED light source unit is arranged so at least a portion of the LED light source unit is immersed in fluid flowing in the apparatus so that the fluid cools the LED light source unit; and
an adapter unit that (i) is positioned between the reactor vessel and the head portion; (ii) is configured to removably attach to the head portion; and (iii) is configured to removably attach to the reactor vessel.

2. The apparatus of claim 1, wherein the LED light source unit is configured to emit UV radiation into the inner vessel in a direction aligned with the second direction.

3. The apparatus of claim 1, wherein the LED light source unit is positioned such that the fluid contacts a front side of the LED light source, through which the UV radiation is emitted, and a back side of the LED light source, opposite of the front side.

4. The apparatus of claim 1, further comprising a flow diffuser in the reactor vessel that is configured to receive fluid from the outer volume and distribute the fluid in the second direction, across a cross-section of the inner vessel.

5. The apparatus of claim 4, wherein the flow diffuser is arranged so that UV radiation emitted from the LED light source unit impinges on the flow diffuser, and the flow diffuser is configured to prevent substantially all of impinging UV radiation from escaping the inner vessel.

6. The apparatus of claim 5, wherein the flow diffuser has a thickness dimension in the second direction, and is configured so that fluid cannot flow in a straight line through the flow diffuser in the second direction.

7. The apparatus of claim 5, wherein the flow diffuser is configured so that the fluid flows within the flow diffuser along tortuous flow paths.

8. The apparatus of claim 5, wherein the outer vessel is composed of plastic.

9. The apparatus of claim 1, wherein the inner vessel is configured to reflect the UV radiation emitted by the LED light source unit.

10. The apparatus of claim 9, wherein the inner vessel is composed of a UV transparent material and includes a reflective layer between the inner vessel and the outer volume.

11. The apparatus of claim 1, wherein the inlet of the inner vessel is positioned at a distal side of the inner vessel with respect to the head portion, and the LED light source unit is positioned at a proximal side of the reactor vessel with respect to the head portion and is configured to emit the UV radiation in a direction that is opposite to the second direction.

12. The apparatus of claim 1, further comprising a filter or filter media that is positioned in the outer volume.

13. The apparatus of claim 1, wherein the adapter unit includes electrical wiring for powering the LED light source unit.

14. The apparatus of claim 1, wherein the head portion is configured to be coupled in-line to a straight pipe such that the inlet conduit can be coupled to a first portion of the straight pipe and the outlet conduit can be coupled to a second portion of the straight pipe.

15. A retrofit fluid treatment apparatus for treating a fluid with ultraviolet (UV) radiation, the apparatus comprising:
(i) a reactor vessel through which the fluid flows and is treated with the UV radiation;
(ii) an LED light source unit configured to emit the UV radiation into the reactor vessel; and
(iii) an adapter unit having (i) a first connection portion by which the adapter unit can be removably attached to a head portion that has an inlet conduit and an outlet conduit that extend in the same lengthwise direction, the inlet conduit and outlet conduit being attachable to piping that conveys the fluid, and (ii) a second connection portion by which the adapter unit can be removably attached to the reactor vessel,
wherein the adapter unit is configured to form a continuous fluid conduit with the head portion and reactor vessel when attached thereto so that a flow path of the fluid enters the head portion at the inlet conduit of the head portion, is then directed to flow into the adapter unit, is then directed to flow through the reactor vessel in a direction that is transverse to the lengthwise direction of the inlet conduit and the outlet conduit of the head portion, and is then directed to flow through the outlet conduit of the head portion.

16. The retrofit fluid treatment apparatus of claim 15, wherein the LED light source unit is mounted on the adapter unit.

17. The retrofit fluid treatment apparatus of claim 15, wherein the adapter includes wiring to supply power to the LED light source unit.

18. The retrofit fluid treatment apparatus of claim 15, wherein the LED light source unit is positioned such that the fluid contacts a front side of the LED light source, through which the UV radiation is emitted, and a back side of the LED light source, opposite of the front side.

19. The retrofit fluid treatment apparatus of claim 15, wherein the adapter unit includes a flow sensor.

20. The retrofit fluid treatment apparatus of claim 15, wherein the reactor vessel includes:
an outer vessel;
an inner vessel housed within the outer vessel; and
an outer volume formed between the inner vessel and the outer vessel and defining a flow path which receives the fluid at a position downstream of the inlet conduit and upstream of the outlet conduit, and is configured to convey the fluid along a first direction toward an inlet of the inner vessel, wherein the fluid then flows within the inner vessel along a second direction that is transverse to the inlet direction and the outlet direction; and
wherein the LED light source unit is configured to emit UV radiation into the inner vessel, and the LED light source unit is arranged so (i) at least a portion of the LED light source unit is immersed in fluid flowing in the apparatus so that the fluid cools the LED light source unit and (ii) UV radiation is primarily emitted into the inner vessel in a direction aligned with the second direction.
